(19) United States
(12) Patent Application Publication
(10) Pub. No.: US 2014/0164417 A1
(43) Pub. Date: Jun. 12, 2014

(54) METHODS FOR ANALYZING USER OPINIONS AND DEVICES THEREOF

(71) Applicant: Infosys Limited, Bangalore (IN)

(72) Inventors: Rajesh Balakrishnan, Bangalore (IN); Bintu G. Vasudevan, Bangalore (IN); Amar Viswanathan, Chennai (IN); Prasanna Venkatesh Raghunathan, Chennai (IN); Umadas Ravindran, Calicut (IN)

(73) Assignee: Infosys Limited, Bangalore (IN)

(21) Appl. No.: 13/946,832

(22) Filed: Jul. 19, 2013

(30) Foreign Application Priority Data
Jul. 26, 2012 (IN) 3055/CHE/2012

(51) Int. Cl. G06F 17/30

(52) U.S. Cl. CPC G06F 17/30684
USPC 707/758

(57) ABSTRACT

A method, non-transitory computer readable medium, and opinion manager device that analyzes user opinions in data includes identifying one or more items of text in data that match one or more of the terms in a database for one or more domain specific concepts. At least the identified one or more items of text in the data for each of the one or more domain specific concepts with the identified one or more terms that match are analyzed based on stored concept analysis rules. One or more reports are provided based on the analysis.

This application claims the benefit of Indian Patent Application Filing No. 3055/CHE/2012, filed Jul. 26, 2012, which is hereby incorporated by reference in its entirety.

### FIELD

This technology generally relates to analyzing user opinions, more particularly, to methods for analyzing user opinions in data and devices thereof.

### BACKGROUND

With explosion of various social platforms, such as blogs, discussion forums and various other types of social media, organizations and enterprise now have huge amount of unstructured information.

Users have got unprecedented power to express personal experiences, provide opinions, or give suggestion and recommendation on almost anything. Analyzing and extracting information from such huge unstructured data becomes challenging problem.

Opinion mining, also known as sentiment analysis, refers to the application of natural language processing, computational linguistics and text analytics to identify and extract subjective information in source materials. Generally, sentiment or opinion analyzer aims to determine the attitude of a speaker or a writer with respect to some topic or the overall contextual polarity of a document.

Basically, the existing technology addresses opinion mining to determine whether the comments are positive, negative or neutral. Given an article or document or data that contains opinions or sentiments about an object, opinion mining aims to extract attributes and components of the object that have been commented on in each article or document and to determine whether the comments are positive, negative or neutral.

### SUMMARY

A method for analyzing user opinions in data includes identifying by a data assessment computing device one or more items of text in data that match one or more of the terms in a database for one or more domain specific concepts. At least the identified one or more items of text in the data for each of the one or more domain specific concepts with the identified one or more terms that match are analyzed by the data assessment computing device based on stored concept analysis rules. One or more reports are provided by the data assessment computing device based on the analysis.

A non-transitory computer readable medium having stored thereon instructions for analyzing user opinions in data comprising machine executable code which when executed by at least one processor, causes the processor to perform steps including identifying one or more items of text in data that match one or more of the terms in a database for one or more domain specific concepts. At least the identified one or more items of text in the data for each of the one or more domain specific concepts with the identified one or more terms that match are analyzed based on stored concept analysis rules. One or more reports are provided based on the analysis.

A data assessment computing device comprising a memory coupled to one or more processors which are configured to execute programmed instructions stored in the memory including identifying one or more items of text in data that match one or more of the terms in a database for one or more domain specific concepts. At least the identified one or more items of text in the data for each of the one or more domain specific concepts with the identified one or more terms that match are analyzed based on stored concept analysis rules. One or more reports are provided based on the analysis.

This technology provides a number of advantages including providing more effective methods, non-transitory computer readable medium and devices for analyzing user opinions in data. The extracted terms or phrases are automatically matched to concepts and then with respect to each match concept at least the extracted terms are analyzed to provide a report on user opinion. This technology also facilitates further updates and revisions to the database or table of terms matched or otherwise linked to concepts as well as allowing new terms and concepts to be added.

### BRIEF DESCRIPTION OF THE DRAWINGS

FIG. 1 is a block diagram of an exemplary network environment which data assessment computing device for analyzing data;

FIG. 2 is a flowchart of an exemplary method for analyzing user opinions;

FIG. 3 is an exemplary table illustrating mapping of concepts and terms;

FIG. 4 is an exemplary blog illustrating blog of a company;

FIG. 5 is an exemplary report generated; and

FIG. 6 is an exemplary weighted correlation matrix.

### DETAILED DESCRIPTION

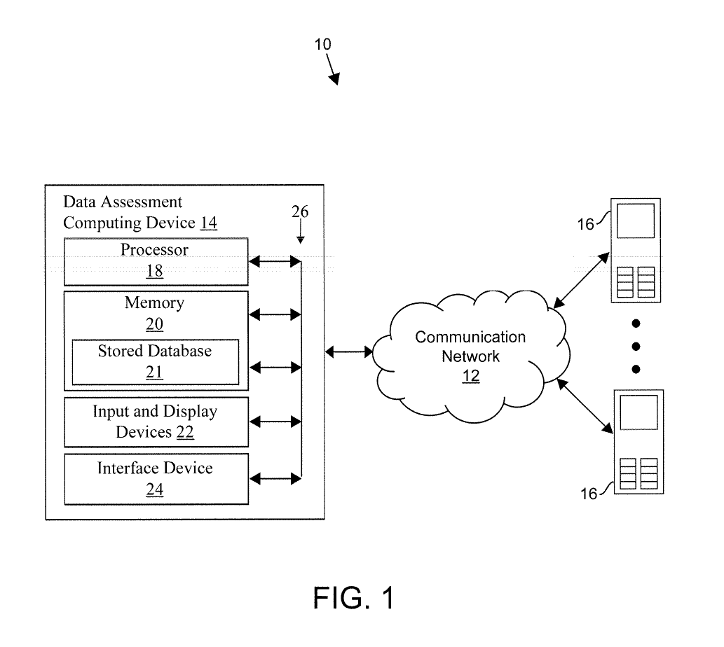

A network environment 10 with an exemplary data assessment computing device 14 for analyzing user opinions is illustrated in FIG. 1. The exemplary environment 10 includes a communication network 12, the data assessment computing device 14, and servers 16 which are coupled together by the communication network 12, although the environment can include other types and numbers of devices, components, elements and communication networks in other topologies and deployments. While not shown, the exemplary environment 10 may include additional opinion databases, product servers which are well known to those of ordinary skill in the art and thus will not be described here. This technology provides a number of advantages including providing more effective methods, non-transitory computer readable medium and devices for analyzing user opinions particularly in an unstructured data, although this technology can be used with other types and amounts of data, such as structured data.

Referring more specifically to FIG. 1, data assessment computing device 14 interacts with the servers 16 through the communication network 12. The communication network 12 may include network topologies such as wide area network (WAN) or local area network (LAN), although the communication network 12 may include any other know network topologies.

The data assessment computing device 14 analyzes user opinions in data as illustrated and described with the examples herein, although data assessment computing device 14 may perform other types and numbers of functions. The data assessment computing device 14 includes at least one processor 18, memory 20, stored database 21 within the memory 20, input and display devices 22, and interface device 24 which are coupled together by bus 26, although data assessment computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

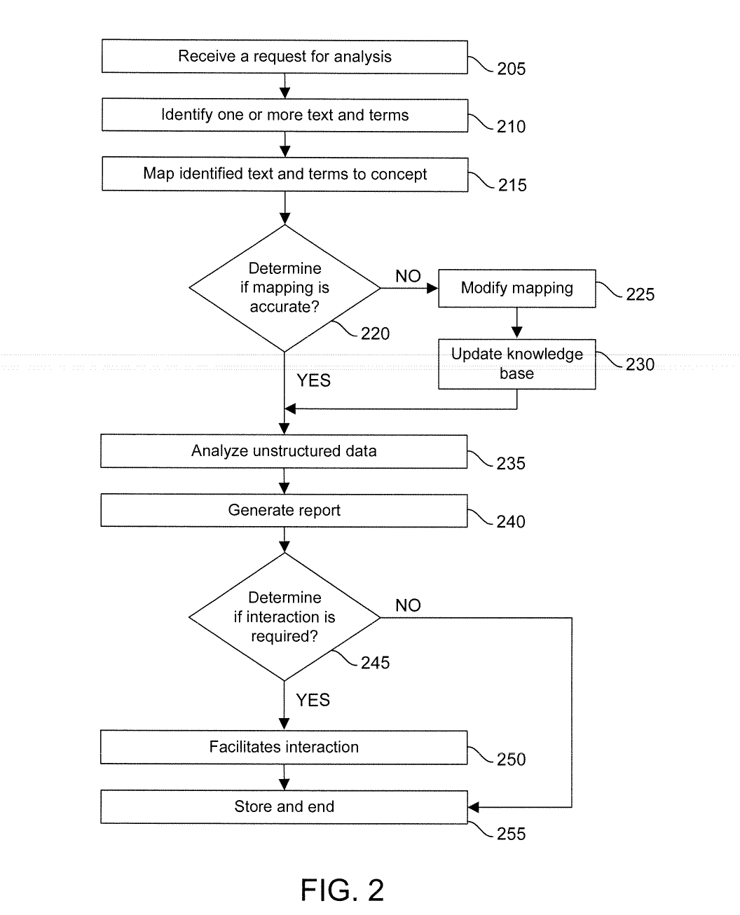

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. The flow chart shown in FIG. 2 is representative of example steps or actions of this technology that may be embodied or expressed as one or more non-transitory computer or machine readable instructions stored in memory 20 that may be executed by the processor(s) 18.

The stored database 21 is database present within the memory 20, although the stored database 21 could be present in any other database server. The stored database 21 includes one or more concepts, instructions to map one or more terms to one or more concepts stored although stored database 21 may store or contain any other information such as concept analysis rules, which are instructions to analyze the concepts mapped. By way of example only, one or more concepts are domain specific high level concepts such as finance, management, legal etc. Additionally, one or more concepts may be one or more sub-concepts relating to them. In another exemplary method, the concepts present in the stored database 21 may also be in form of ontology, a database or any data structure which are read into the memory 20 one time from the stored database 21. Further, the stored database 21 can learn and update automatically by itself based any interactions or modifications performed on the one or more concepts.

Input and display devices 22 enables a user, such as an administrator, to interact with the data assessment computing device 14, such as to input and/or view data and/or to configure, program and/or operate it by way of example only. Input devices may include a keyboard and/or a computer mouse and display devices may include a computer monitor, although other types and numbers of input devices and display devices could be used.

The interface device 24 in the data assessment computing device 14 is used to operatively couple and communicate between the data assessment computing device 14 and the servers 16 which are all coupled together the communication network 12. By way of example only, the interface device 24 can use TCP/IP over Ethernet and industry-standard protocols, including NFS, CIFS, SOAP, XML, LDAP, and SNMP, although other types and numbers of communication networks, can be used.

In this example, the bus 26 is a hyper-transport bus in this example, although other bus types and links may be used, such as PCI.

Each of the servers 16 include a central processing unit (CPU) or processor, a memory, an interface device, and an I/O system, which are coupled together by a bus or other link, although other numbers and types of network devices could be used.

Generally, servers 16 includes any one or in combination of reviews of a product, comments or reviews on a company/ organizations website, comments or reviews on a social network, comments/ reviews posted on blogs, although other types of information may be present in each of the server 16. A series of applications may run on the servers 16 that allow the transmission of data, such as a data file or metadata, requested by the data assessment computing device 14. It is to be understood that the servers 16 may be hardware or software or may represent a system with multiple servers 16, which may include internal or external networks. In this example the servers 16 may be any version of Microsoft® IIS servers or Apache® servers, although other types of servers may be used.

Although an exemplary network environment 10 with the data assessment computing device 14, servers 16, and communication network 12 are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

An exemplary method for analyzing user opinions will now be described with reference to FIGS. 1-5. In step 205, the data assessment computing device 14 receives a request to analyze user opinions in unstructured data which are stored in the memory of the server 16, although the data assessment computing device 14 may receive other types of requests to analyze other types and amounts of data, such as request to analyze user opinions in structured data. In this example, unstructured data generally refers to information that does not have a pre-defined data model and are typically text-heavy, but may also contain data, such as dates, numbers, and facts. Further, structured data generally refers to data which reside in the fixed fields/location in a database/record. Additionally, the data assessment computing device 14 may receive information regarding the one or more domain specific concepts to be analyzed from the user. Domain specific concepts each generally relate to a different topic. With this technology, further additions, subtractions and refinement of the terms can be made and may be necessary. For example, for the domain specific concept salary the term hike might by matched together. Hike when used in the domain concept of salary generally means increment in salary, in sharp contrast, when used in the domain of adventure sports generally means to go on extended walk. Accordingly, this technology allows further refinement of terms.

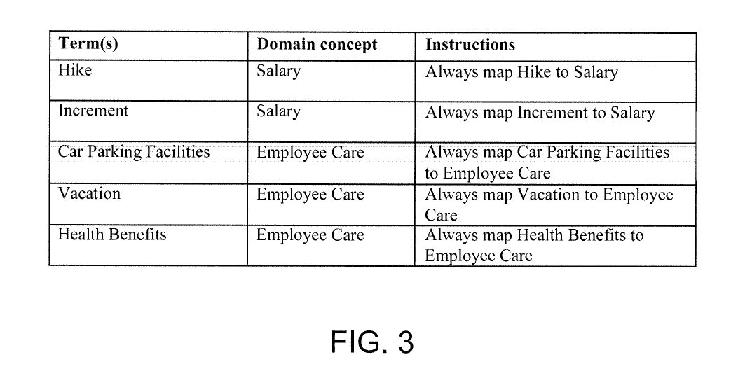

In step 210, the data assessment computing device 14 identifies one or more items of text that match with one or more terms which are terms/phrases/images/sentences in the unstructured data relating to the one or more domain specific concepts, although the data assessment computing device 14 may additionally extract or obtain or stored the identified one or more terms. In this example, one or more items of the text relate to terms or phrases present in the text. The data assessment computing device 14 identifies the terms which relate to one or more domain specific concepts based on the stored database 21 present in the memory 20. The stored database 21 contains a table, illustrated in FIG. 3 which indicates the relation of the one or more terms to the one or more domain specific concepts. In this example, the data assessment computing device 14 determines all terms which relate to domain concepts of salary and employee care based on the stored database 21. The table in the stored database 21 indicates that terms such as such as hike, increment, vacation, health benefits and car parking facilities etc generally relate to the domain specific concepts of salary and employee care.

In step 215, the data assessment computing device 14 maps each of the identified one or more items to each of the one or more domain specific concepts. Additionally, the data assessment computer device 14 refers to the stored database 21 which contains instructions for mapping the terms to the concepts as illustrated in FIG. 3. In this example, hike, and increment are mapped to salary and vacation, car parking facilities and health benefits are mapped to employee care based on the existing instructions present in the stored database 21.

In step 220, the data assessment computing device 14 determines if the mapping of the one or more terms to the one or more domain specific concepts is accurate based on received user input, although other manners for determining if the mapping is correct, such as based on one or more stored criteria can be used. In this example, the data assessment computing device 14 can determine the accuracy of the mapping by referring to the one or more rule base present within the stored database 21. The rule base contains regular expression which assists the data assessment computing device 14 in determining the accuracy of the mapping. In another example, the data assessment computing device 14 provides the mapping of the one or more terms on the input and display devices 22 so that the user can verify the accuracy. The user can check if the one or more terms are accurately mapped to the one or more domain specific concepts by manually verifying each mapping. In this example, the one or more terms mapped to the one or more domain specific concepts are color coded to assist the user in verification. Additionally, the data assessment computing device 14 may request the user to provide answers to a set of questions and determine the accuracy of the mapping based on the answers to these questions. For example, the data assessment computing device 14 may request answers for questions such as “Does the term 1, accurately map to concept 1?”, although the data assessment computing device 14 may request answers for other type of questions. By way of example only, the user can check for the accuracy of the mapping via a graphical user interface provided through a web application by the data assessment computing device 14. If the data assessment computing device 14 determines the mapping is not accurate, then a No branch is taken to step 225.

In step 225, the data assessment computing device 14 modifies the mapping to make it accurate based on additional instructions received directly from the user or the user may update the instructions stored in the stored database 21 and the data assessment computing device 14 modifies the mapping based on the additional instructions stored in the stored database 21. In this example, since the opinion manager computing device determines that the mapping is accurate, there are no further modifications.

In step 230, the data assessment computing device 14 may update the instructions present in the table of the stored database 21 based on the modification performed in step 225 for future reference. In this example, the opinion manger computing device 14 need not update any instruction present in the stored database 21.

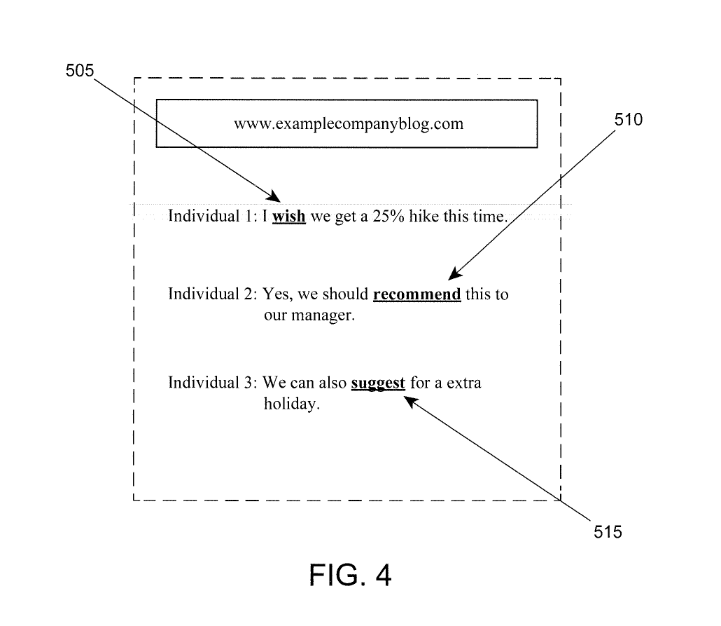

If back in step 220 the data assessment computing device 14 determines that the mapping is accurate, then Yes branch is taken to step 235. In step 235, the data assessment computing device 14 analyzes the identified one or more items of text in unstructured data by looking for the frequency of occurrences of one or more terms or checking for the suggested action to be taken for each of the concepts, although other types and number of analyses may also be performed by the data assessment computing device 14 such as analyzing the terms adjacent or all the terms in the sentence/phrase to the one or more terms to identify the suggestions or any other techniques based on one or more stored concept rules. For example, the data assessment computing device 14 checks for the action recommended/suggested for each of the one or more domain specific concept by an individual who posted the review/opinion by checking for opinion related keywords, such as recommend, desired, wish, suggest or possible as illustrated in FIG. 4, although any other methods of checking for suggested may be performed. In this example, the data assessment computing device 14 analyzes the organizations website/blog to check for the suggested action to be taken to each of the terms. For example, the data assessment computing device 14 may look for suggested action for hike where the employees of the company may have wished at reference number 505 for a 25% hike, another employee recommending at reference number 510 the same to the manager, or another employee suggesting at reference number 515 for an extra holiday.

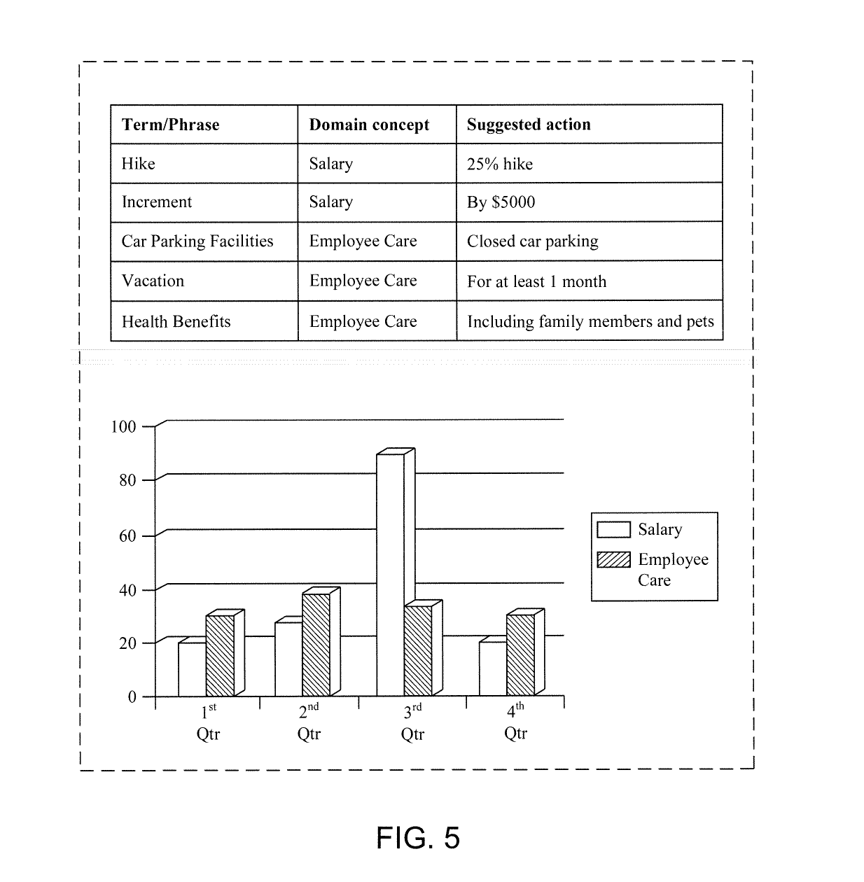

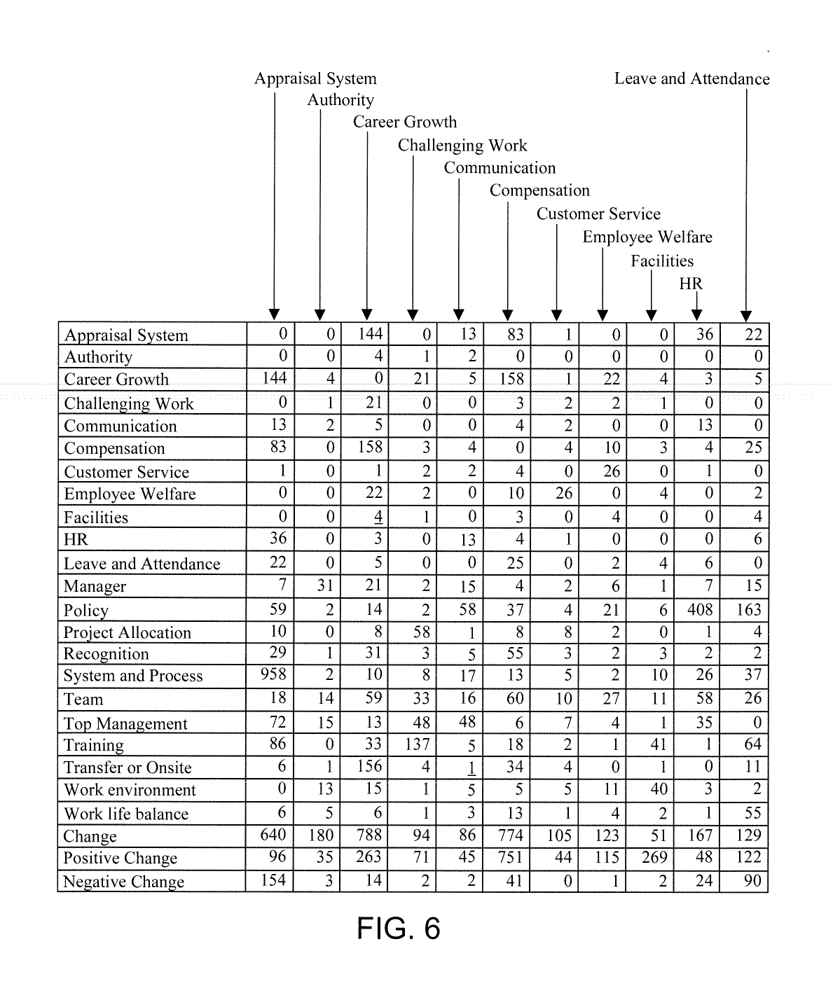

In step 240, the data assessment computing device 14 generates one or more reports based on the analysis in step 235 to suggested or recommend actions as illustrated in FIG. 5, although the data assessment computing device 14 could take other types and numbers of actions, such as generating a reporting email or taking another programmed action. By way of example, the data assessment computing device 14 may generate one or more reports, such as a report which illustrates the analyzed results in a weighted correlation matrix as illustrated in FIG. 6, although the data assessment computing device 14 may generate a graphical user interface which comprises a report which is displayed on the input and display device 21. The weighted correlation matrix represents the count of the occurrence one or more items mapped to the one or more domain specific concepts. The data inside report generated may be in the form of graphs, tables, although the report may contain any form of additional data. In this example, the data assessment computing device 14 generates a graphical user interface on the input and display device 21 which graphically represents the hike and increment mapped to salary and vacation, benefits and parking facilities mapped to employee benefits. Further, the data assessment computing device 14 along with the mapping provides the suggested action for hike such as to provide a 25% hike on the employee's present salary. Additionally, the opinion manager computing device 14 while providing the suggested action may perform mathematical functions, although the opinion manger computing device 14 may perform other functions to generate the suggested actions in the report. For example, one employee of the company may wish for 25% hike in the salary and another employee may wish for a 30% hike in the salary in which case the opinion manager computing device 14 may perform mathematical operation such as average to identify what the employee generally wants the hike to be which is around 27.5% and this is generated as a suggested action in the one or more reports.

In step 245, the data assessment computing device 14 determines if interaction is required for further analysis of the generated one or more reports. If the data assessment computing device 14 determines that interaction is not required, then the No branch is taken to step 255 where this example of the process ends. If the data assessment computing device 14 determines that interaction is required, then the Yes branch is taken to step 250. In this example, the data assessment computing device 14 takes the Yes branch to step 250 on determining that further interaction is required with the generated one or more reports.

In step 250, the data assessment computing device 14 facilitates interaction with the one or more reports generated via the input and display devices 21. The opinion manger computing device 14 may facilitate interactions, such analyzing each of the graph, table separately or drill down to particular article/comment/ review posted or highlight the corresponding phrase in the article. In this example, the data assessment computing device 14 facilitates interaction by drilling down to a particular article/comment/review to discover what employees are saying, their likes and dislikes, the changes that they suggest etc. and then adding those to the generated report to provide the end user with a better context regarding the comments and expressed opinions.

In step 255, the data assessment computing device 14 stores the generated one or more reports in memory 20, although the data assessment computing device 14 could take other types and numbers of actions and then this example of the process ends.

This exemplary technology provides an effective method, non-transitory computer readable medium and apparatus for analyze vast amounts of data to provide objective insight, such as analyzed data on what people are talking about, what people like or dislike, what are pain points and what are suggestions for changes and improvements. Additionally, this exemplary automated analysis significantly reduces manually reviewing and then analyzing larges amounts of unstructured data. Further, this exemplary automated analysis removes both human error and human subjectivity from the provided analysis.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for analyzing user opinions in data, the method comprising:
identifying by the data assessment computing device one or more items of text in data that match one or more of the terms in a database for one or more domain specific concepts;
analyzing by the data assessment computing device based on stored concept analysis rules at least the identified one or more items of text in the data for each of the one or more domain specific concepts with the identified one or more terms that match; and
providing by the data assessment computing device one or more reports based on the analysis.

2. The method as set forth in claim 1 wherein the analyzing further comprising identifying by the data assessment computing device one or more actions associated with each of the one or more domain specific concepts with the identified one or more terms that match.

3. The method as set forth in claim 2 further comprising providing by the data assessment computing device the identified one or more actions in the one or more reports.

4. The method as set forth in claim 1 further comprising determining by the data assessment computing device accuracy of mapping of the one or more terms to the one or more domain specific concepts based on one or more of a rule base or one or more user inputs.

5. The method as set forth in claim 4 wherein the determining further comprises modifying by the data assessment computing device the one or more terms matched to the one or more domain specific concepts in the stored database when the mapping is determined to be inaccurate.

6. The method as set forth in claim 1 wherein the providing further comprises:
providing by the data assessment computing device a graphical representation of the one or more reports; and
facilitating by the data assessment computing device interaction with the graphical representation.

7. The method as set forth in claim 1 further comprising storing by a data assessment computing device the one or more terms for each of one or more domain specific concepts in the stored database.

8. A non-transitory computer readable medium having stored thereon instructions for analyzing user opinions in data comprising machine executable code which when executed by at least one processor, causes the at least one processor to perform steps comprising:
identifying one or more items of text in data that match one or more of the terms in a database for one or more domain specific concepts;
analyzing based on stored concept analysis rules at least the identified one or more items of text in the data for each of the one or more domain specific concepts with the identified one or more terms that match; and
providing one or more reports based on the analysis.

9. The medium as set forth in claim 8 wherein the analyzing further comprises identifying one or more actions associated with each of the one or more domain specific concepts with the identified one or more terms that match.

10. The medium as set forth in claim 8 further comprising providing the identified one or more actions in the one or more reports.

11. The medium as set forth in claim 8 further comprising determining accuracy of mapping of the one or more terms to the one or more domain specific concepts based on one or more of a rule base or one or more user inputs.

12. The medium as set forth in claim 11 further comprising modifying the one or more terms matched to the one or more domain specific concepts in the stored database when the mapping is determined to be inaccurate.

13. The medium as set forth in claim 8 wherein the providing further comprises:
providing a graphical representation of the one or more reports; and
facilitating interaction with the graphical representation.

14. The medium as set forth in claim 8 further comprising storing the one or more terms for each of one or more domain specific concepts in the stored database.

15. A data assessment computing device comprising:
one or more processors;
a memory, comprising a stored database, wherein the memory coupled to the one or more processors which are configured to execute programmed instructions stored in the memory comprising:
identifying one or more items of text in data that match one or more of the terms in a database for one or more domain specific concepts;
analyzing based on stored concept analysis rules at least the identified one or more items of text in the data for each of the one or more domain specific concepts with the identified one or more terms that match; and
providing one or more reports based on the analysis.

16. The device as set forth in claim 15 wherein the one or more processors is further configured to execute programmed instructions stored in the memory further comprising identifying one or more actions associated with each of the one or more domain specific concepts with the identified one or more terms that match.

17. The device as set forth in claim 16 wherein the one or more processors is further configured to execute programmed instructions stored in the memory further comprising providing the identified one or more actions in the one or more reports.

18. The device as set forth in claim 15 wherein the one or more processors is further configured to execute programmed instructions stored in the memory further comprising determining accuracy of mapping of the one or more terms to the one or more domain specific concepts based on one or more of a rule base or one or more user inputs.

19. The device as set forth in claim 18 wherein the one or more processors is further configured to execute programmed instructions stored in the memory further comprising modifying the one or more terms matched to the one or more domain specific concepts in the stored database when the mapping is determined to be inaccurate.

20. The device as set forth in claim 15 wherein the one or more processors is further configured to execute programmed instructions stored in the memory wherein the providing further comprises:
providing a graphical representation of the one or more reports; and
facilitating interaction with the graphical representation.

21. The device as set forth in claim 15 wherein the one or more processors is further configured to execute programmed instructions stored in the memory further comprising storing the one or more terms for each of one or more domain specific concepts in the stored database.
